(19) United States
(12) Patent Application Publication
(10) Pub. No.: US 2009/0086625 A1
(43) Pub. Date: Apr. 2, 2009

(54) Method and Apparatus For Providing a Distributed Control Plane for a Mobility Home Agent

(76) Inventors: Thyagarajan Nandagopal, Edison, NJ (US); Thomas Y. Woo, Short Hills, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 11/863,354

(22) Filed: Sep. 28, 2007

(51) Int. Cl. H04J 3/26

(52) U.S. Cl. 370/227

(57) ABSTRACT

The invention includes a method and apparatus for providing a distributed control plane for a mobility home agent by enabling multiple home addresses associated with multiple home agents to be assigned to a mobile node contemporaneously. A first home agent assigns a first home address to the mobile node. The first home agent propagates the first home address to the mobile node, which stores the first home address. The first home address is also propagated to a naming server and stored by the naming server for the mobile node. A second home agent, or the first home agent on behalf of the second home agent, assigns a second home address to the mobile node. The first home agent, or second home agent, propagates the second home address to the mobile node, which stores the second home address while continuing to store the first home address. The second home address is also propagated to the naming server and stored by the naming server for the mobile node while the naming server continues to store the first home address for the mobile node.

### FIELD OF THE INVENTION

The invention relates to the field of communication networks and, more specifically, to packet routing in mobile networks.

### BACKGROUND OF THE INVENTION

A packet-based network employing a mobility management protocol, e.g., Mobile IP, allows mobile node users to move between networks while maintaining a permanent IP address, thereby enabling mobile node users to maintain transport layer connections, and higher-layer connections, even as mobile node users change their point-of-connection to the packet-based network. Thus, a mobile network employing a mobility management protocol such as Mobile IP enables a mobile node (MN) to maintain transport and higher-layer connections with one or more host devices available on the mobile network. For a packet-based network employing Mobile IP, mobility management for mobile node users is provided using Home Agents (HAs), Foreign Agents (FAs), and other mobility management capabilities.

In existing networks employing Mobile IP, a MN can associate with a HA either statically or dynamically. Where a MN associates with a HA statically, the static attachment of the MN to the HA is preconfigured such that the MN always associates with the same HA. Where a MN associates with a HA dynamically, the dynamic attachment of the MN to the HA is made at the time that the MN initially registers with the HA. The dynamic attachment of a MN with a HA allows optimal routing to the MN when the MN has moved away from the home network and attempts to re-register, thereby allowing the MN to select a HA closer to its current mobility domain, resulting in a lower penalty for triangular routing.

Disadvantageously, existing approaches using static and dynamic associations between MNs and HAs have numerous drawbacks. When a MN is statically attached to its HA, the routes used when the MN moves to a different mobility domain will be suboptimal due to the distance between the MN and the HA. While this problem may be partially overcome when the MN dynamically associates with a HA, there are other problems associated with dynamic associations. For example, when a MN has an existing session with a first HA and moves to a mobility domain controlled by a second HA, if the MN remains associated with the first HA any new sessions will use suboptimal routes; however, if the MN changes from associating with the first HA to the second HA, any existing sessions with the first HA will be lost.

### SUMMARY OF THE INVENTION

Various deficiencies in the prior art are addressed through the present invention of a method and apparatus for providing a distributed control plane for a mobility home agent. The invention provides the distributed control plane by enabling multiple home addresses associated with multiple home agents to be assigned to a mobile node contemporaneously. A first home agent assigns a first home address to the mobile node. The first home agent propagates the first home address to the mobile node, which stores the first home address. The first home address is also propagated to a naming server and stored by the naming server for the mobile node. A second home agent, or the first home agent on behalf of the second home agent, assigns a second home address to the mobile node. The first home agent, or second home agent, propagates the second home address to the mobile node, which stores the second home address while continuing to store the first home address. The second home address is also propagated to the naming server and stored by the naming server for the mobile node while the naming server continues to store the first home address for the mobile node.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network;

FIG. 2 depicts a high-level block diagram of the communication network of FIG. 1 including exemplary routing paths according to the present invention;

FIG. 3 depicts a method according to one embodiment of the present invention;

FIG. 4 depicts a method according to one embodiment of the present invention;

FIG. 5 depicts a method according to one embodiment of the present invention; and

FIG. 6 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention provides a distributed control plane for a mobility home agent by enabling multiple home addresses, associated with multiple mobility home agents, to be assigned to a mobile node. The multiple home addresses assigned to the mobile node are provided to the mobile node and to one or more naming servers. The home addresses may be assigned to the mobile node and propagated to the mobile node in many ways. The home addresses may be propagated to the naming server(s) in many ways. These embodiments may be better understood with respect to the figures and the associated description of the figures, which follows.

The present invention, by enabling multiple home addresses to be assigned to a mobile node contemporaneously, enables the mobile node to move within the mobile communication network while maintaining existing sessions of the mobile node using mobility home agents with which the mobile node is already associated, and in a manner for associating with additional mobility home agents which may provide improved routes for new sessions of the mobile node. Thus, the present invention provides improvements over existing mobility networks utilizing existing static or dynamic mobile node association techniques.

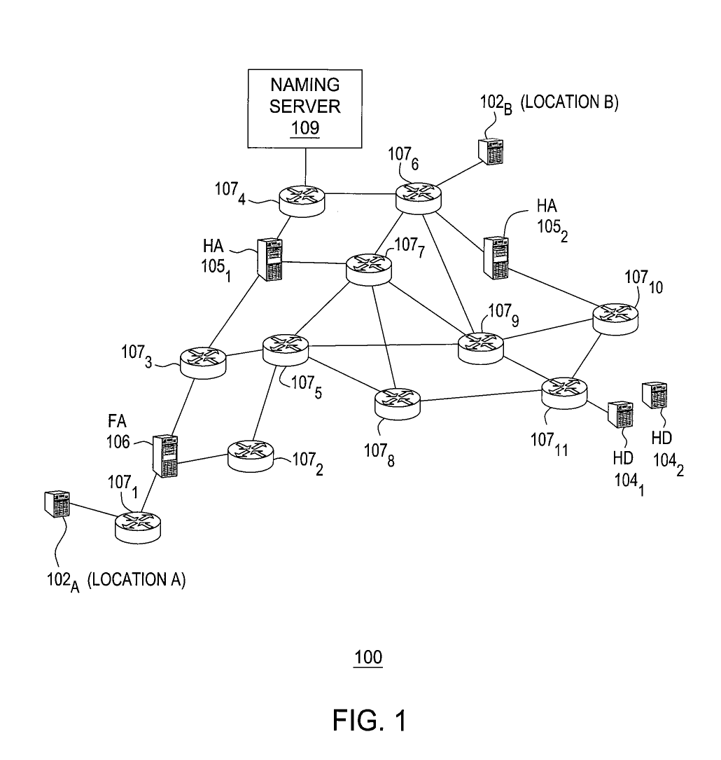

FIG. 1 depicts a high-level block diagram of a communication network supporting mobility using a mobility management protocol. Specifically, communication network 100 includes a mobile node (MN) 102, a first host device (HD) 104₁ and a second host device (HD) 104₂ (collectively, HDs 104), a first home agent (HA) 105₁ and a second home agent (HA) 105₂ (collectively, HAs 105), a plurality of routing elements (REs) 107₁-107₁₁ (collectively, REs 107), and a naming server (NS) 109. The MN 102 may communicate via a Foreign Agent (FA) 106, which is an optional element. As depicted in FIG. 1, components of communication network 100 communicate using a plurality of communication links (CLs) 115.

The MN 102 includes any mobile user device capable of changing its point of attachment with communication network 100. For example, MN 102 may include a laptop, mobile phone, PDA, and the like. The HDs 104 include any network devices capable of communicating with MN 102. For example, HDs 104 may include application servers, content servers, and the like, as well as various combinations thereof.

The REs 107 propagate packets between MN 102 and HDs 104. The REs 107 include any packet routing/forwarding elements. For example, REs 107 may include switches, routers, packet forwarding elements (e.g., PFEs of a disaggregated router, where the PFEs are organized in network domains controlled by one or more control elements), and the like, as well as various combinations thereof.

The first HA 105₁ and second HA 105₂ each operate as a Mobile IP Home Agent. The HAs 105 each serve MN 102 (as well as other MNs, which are omitted for purposes of clarity). The HAs 105 are adapted for assigning home addresses to MN 102, routing packets for MN 102 (e.g., tunneling packets received from HDs 104 to MN 102), and performing like functions typically performed by home agents in mobile networks. The HAs 105 each perform additional address assignment and distribution functions associated with the present invention.

The first HA 105₁ and second HA 105₂ each maintain a pool of available network-layer addresses (e.g., IP addresses). The HAs 105 each receive a pool of available addresses from one or more address management systems (e.g., from one or more Dynamic Host Configuration Protocol (DHCP) servers, and/or from one or more Authorization-Authentication-Accounting (AAA) servers, which have been omitted for purposes of clarity). When a mobile node registers with one of the HAs 105, the HA 105 assigns one of the available addresses to the mobile node. The addresses are referred to herein as home addresses.

The FA 106 operates as a Mobile IP Foreign Agent. The FA 106 serves MN 102 (as well as other MNs, which are omitted for purposes of clarity). The FA 106 functions as a router. The FA 106 stores information about mobile nodes that visit its network (illustratively, MN 102 which is served by FA 106 while MN 102_{A} is at location A). The FA 106 is depicted as an optional element because mobile nodes may associate directly with a home agent (illustratively, HA 105) or may associate a home agent indirectly via a foreign agent (illustratively, FA 106).

The NS 109 is a naming server. The NS 109 maintains a mapping for each mobile node that maps the name of the mobile node (e.g., the NAI or some other identifier) to one or more home addresses assigned to the home node by one or more home agents. For example, NS 109 maintains an entry for MN 102 that initially includes a first home address assigned when MN 102 associates with first HA 105₁ and later includes a second home address assigned when MN 102 associates with second HA 105₂. For example, NS 109 may be a Domain Name System (DNS) server, a Session Initiation Protocol (SIP) name server, or any other similar naming server.

Although depicted and described with respect to specific numbers and configurations of MNs 102, HDs 104, HAs 105, FAs 106, REs 107, NSs 109, and CLs 115, the present invention is not limited to such numbers and/or configurations of MNs 102, HDs 104, HAs 105, FAs 106, REs 107, NSs 109, and CLs 115. Furthermore, although depicted and described with respect to a two HAs (for purposes of clarity), the present invention may be used to provide a distributed control plane for a mobility network having any number of mobility home agents. Thus, using the present invention, a mobile node may associate with any number of home agents.

As depicted in FIG. 1, MN 102 moves within communication network 100. The MN 102 begins at one location. Specifically, MN 102 initially accesses communication network 100 at a first location (illustratively, MN 102 is denoted as MN 102_{A} at location A where MN 102_{A} accesses the network via RE 107₁). The MN 102 then moves to a different location. Specifically, MN 102 subsequently accesses communication network 100 at a second location (illustratively, MN 102 is denoted as MN 102_{B} at location B where MN 102_{B} accesses the network via RE 107₆).

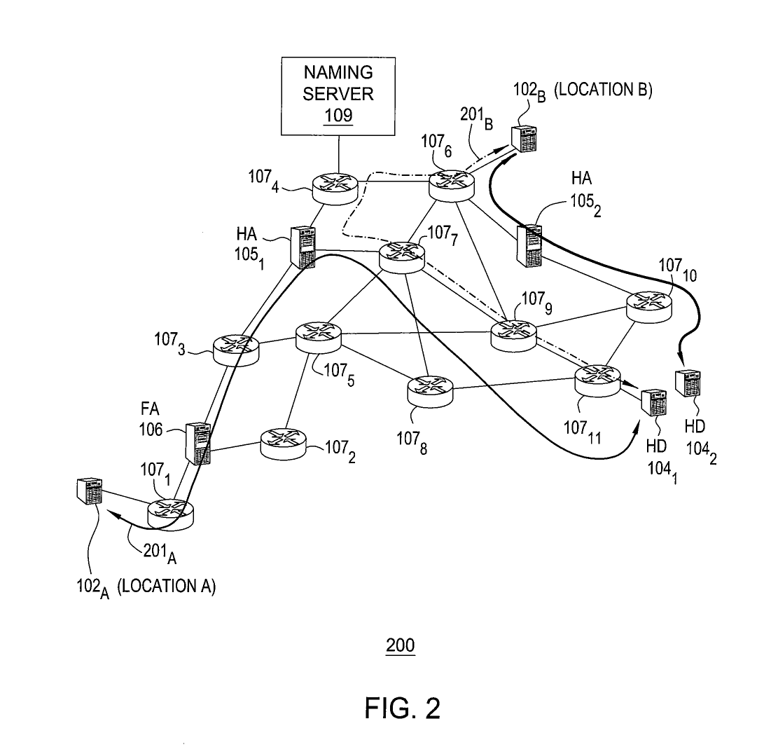

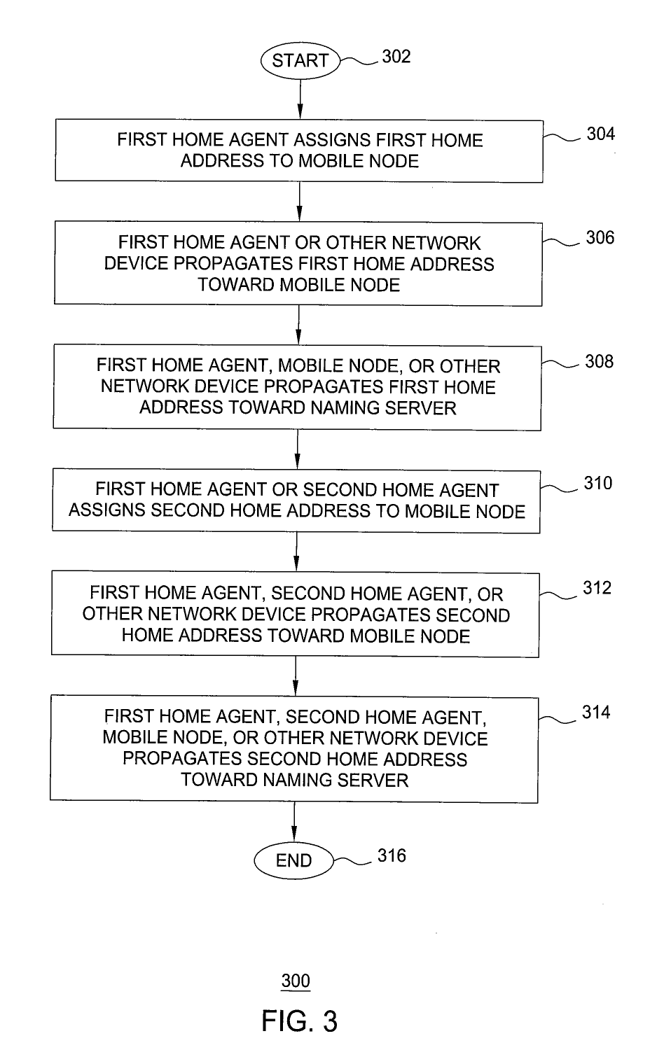

As described herein, in accordance with the present invention, MN 102 is assigned multiple home addresses from multiple home agents (illustratively, HAs 105). The MN 102 is assigned a first home address (associated with first HA 105₁) when MN 102 accesses the network at location A and registers with first HA 105₁. The MN 102 is assigned a second home address (associated with second HA 105₂) when MN 102 accesses the network at location B and registers with second HA 105₂. The assignment and distribution of home addresses for a mobile node may be better understood with respect to FIG. 2 and FIG. 3.

FIG. 2 depicts a high-level block diagram of the communication network of FIG. 1 in which multiple home address, associated with multiple home agents, are assigned to one mobile node, thereby enabling multiple sessions utilizing multiple home agents to be active contemporaneously. Specifically, communication network 100 supports a first routing path 201 between first HD 104₁ and MN 102 and a second routing path 202 between second HD 104₂ to MN 102. The first routing path 201 changes as MN 102 moves (i.e., beginning as first routing path 201_{A} between first HD 104₁ and MN 102_{A} when MN 102 is at location A, and changing to first routing path 201_{B} between first HD 104₁ and MN 102_{B} when MN 102 is at location B). The first routing path 201 and second routing path 202 co-exist by enabling multiple home addresses, associated with multiple HAs 105, to be assigned to MN 102 contemporaneously. The formation of the first routing path 201 and the second routing path 202 may be better understood with respect to the following description.

Referring to FIG. 2, MN 102 initially accesses communication network 100 via RE 107₁ (denoted as MN 102_{A} at location A). The MN 102_{A} initially associates with first HA 105₁ (which may be established statically or dynamically). The MN 102_{A} requests a first home address from first HA 105₁. The first HA 105₁ receives the association request from MN 102_{A} and assigns a first home address (denoted as HomeAddr1) to MN 102. The first HA 105₁ provides the first home address to MN 102_{A} for first HA 105₁. The MN 102_{A} stores the first home address. The first home address is also provided to NS 109. The first home address may be provided to NS 109 by first HA 105₁, MN 102, or some other element adapted for updating NS 109 with home address information for mobile nodes. The NS 109 stores the first home address as part of a naming record associated with MN 102 such that the first home address HomeAddr1 is associated with MN 102.

The MN 102 may then communicate with first HD 104, using first routing path 201_{A} (i.e., the routing path to MN 102_{A} when MN 102 is associated with communication network at location A) via first HA 105₁. For example, as depicted in FIG. 2, first routing path 201_{A} from first HD 104₁ to MN 102_{A} traverses RE 107₁₁, RE 107₉, RE 107₇, first HA 105₁, RE 107₃, FA 106, and RE 107₁. For example, first HD 104₁ provides packets intended for MN 102_{A} to first HA 105₁ which then tunnels the packets to MN 102_{A} via the remainder of first routing path 201_{A}. Similarly, for example, MN 102_{A} may tunnel packets intended for first HD 104₁ to first HA 105₁ which then propagates the packets to first HD 104₁ via the remainder of first routing path 201_{A}.

Referring to FIG. 2, assume that after associating with first HA 105₁, MN 102 moves from location A to location B (denoted as MN 102_{B} at location B) and accesses communication network 100 via RE 107₆. The MN 102 then attempts to associate with second HA 105₂, while continuing to maintain the association with first HA 105₁. The MN 102_{B} requests a second home address, either from first HA 105₁ or second HA 105₂. The first HA 105₁ or second HA 105₂ receives the association request from MN 102_{B} and assigns a second home address (denoted as HomeAddr2) to MN 102 for second HA 105₂. The first HA 105₁ or second HA 105₂ provides the second home address to MN 102_{B}. The MN 102_{B} stores the second home address while continuing to store the first home address. The second home address is provided to NS 109. The second home address may be provided to NS 109 by first HA 105₁, second HA 105₂, MN 102, or some other element adapted for updating NS 109 with home address information for mobile nodes. The NS 109 updates an existing naming record for MN 102 to include the second home address in addition to the first home address.

As described above, for each new home address assigned to MN 102 as MN 102 moves about communication network 100, the new home address may be assigned to MN 102 by any of the previous HAs 105 with which MN 102 previously associated or the new HA 105 with which MN 102 is currently attempting to associate. In one embodiment, for example, there may be some explicit or implicit association between HAs 105 (illustratively, between the first HA 105₁ and the second HA 105₂) to ensure that one of the HAs 105 assigns the second home address to MN 102, and that the second home address is propagated to MN 102 and to NS 109. In this embodiment, such an explicit or implicit association between HAs 105 enables assignment and distribution of home addresses for MN 102 using various implementations.

In one embodiment, for example, first HA 105₁ may assign the second home address for MN 102 (first HA 105₁ performs this function for second HA 105₂) and provide the assigned home address to second HA 105₂. In this embodiment, one or more of first HA 105₁, second HA 105₂, or some other network element may communicate the second home address to MN 102 and/or NS 109.

In another embodiment, for example, second HA 105₂ may assign the second home address for MN 102. In one such embodiment, one or more of the first HA 105₁, second HA 105₂, or some other network element may communicate the second home address to MN 102 and/or NS 109. In another such embodiment, the first HA 105₁, or some other network element, may refer MN 102 to the second HA 105₂.

Although specific embodiments are depicted and described herein, the assignment and distribution of home addresses associated with different home agents for a mobile node may be implemented in various other ways using explicit and/or implicit associations between home agents.

The MN 102 may then communicate with first HD 104₁ using first routing path 201_{B} (i.e., the routing path to MN 102_{B} when MN 102 is associated with communication network 100 at location B) via first HA 105₁. For example, as depicted in FIG. 2, first routing path 201_{B} from first HD 104₁ to MN 102_{B} traverses RE 107₁₁, RE 107₉, RE 107₇, first HA 105₁, RE 107₄, and RE 107₆. For example, first HD 104₁ provides packets intended for MN 102_{B} to first HA 105₁, which then tunnels the packets to MN 102_{B} via the remainder of first routing path 201_{B}. Similarly, for example, MN 102_{B} may tunnel packets intended for first HD 104₁ to first HA 105₁, which then propagates the packets to first HD 104₁ via the remainder of first routing path 201_{B}.

Thus, the present invention enables the session between first HD 104₁ and MN 102 via first HA 105₁ to remain active even though second HA 105₂ is better suited to serve MN 102 based on the current location of MN 102 (i.e., at location B). In other words, even though first routing path 201_{B} is sub-optimal (in the sense that MN 102 may now associate with second HD 104₂ and thus could establish a shorter path along the route including first HD 104₁, RE 107₁₁, RE 107₁₀, second HA 105₂, RE 107₆, and MN 102_{B}), the present invention at least enables the existing session between first HD 104₁ and MN 102 to remain active even as MN 102 moves within communication network 100 and associates with a different home agent (illustratively, second HA 105₂). Although dynamic associations according to existing networks would have resulted in the optimal routing path, the existing session between first HD 104₁ and MN 102 would be lost and would need to be reestablished.

Referring to FIG. 2, after multiple home addresses have been assigned for MN 102, when a new host device (illustratively, second HD 104₂) initiates a new session with MN 102 (i.e., with MN 102_{B} assuming MN 102 is still at location B) the new host device must obtain one of the home addresses associated with MN 102 for use in communicating with MN 102 via one of the home agents (illustratively, HAs 105) associated with MN 102. In one embodiment, NS 109 will serve all home addresses associated with MN 102 to second HD 104₂. In this embodiment, NS 109 serves both the first and second home addresses (HomeAddr1 and HomeAddr2) to second HD 104₂ and second HD 104₂ selects one of the home addresses to use to contact MN 102. In another embodiment, NS 109 selects one of the home addresses associated with MN 102 (either HomeAddr1 or HomeAddr2) and provides the selected home address second HD 104₂.

More generally, using the present invention, when a new host device initiates a new session with mobile node having multiple associated home addresses, the new host device uses one of the multiple home addresses associated with the mobile node for communicating with the mobile node via one of the home agents associated with the home address that is used. In one embodiment, the naming server serves all home addresses associated with the mobile node to the new host device and the new host device selects one of the home addresses to use to contact the mobile node. In another embodiment, the naming server selects one of the multiple home addresses associated with the mobile node and provides the selected home address to the new host device for use in contacting the mobile node. In such embodiments, the one of the multiple home addresses may be selected in any manner (e.g., in a manner for optimizing the routing the path between the new host device and the mobile node, randomly for load balancing purposes, and the like).

Referring to FIG. 2, after multiple home addresses have been assigned for MN 102, when MN 102 wishes to initiate a new session with an existing HD (illustratively, one of the HDs 104) or a new HD (omitted for clarity), the MN 102 uses one of the home addresses associated with MN 102 to communicate with the HD via one of the home agents associated with MN 102. In one embodiment, the HA (i.e., one of first HA 105₁ or second HA 105₂) selects one of the home addresses associated with MN 102 (either HomeAddr1 or HomeAddr2) and provides the selected home address to MN 102. In another embodiment, MN 102 may select one of the home addresses (which are stored locally on MN 102) to use for communicating with the HD, or may perform stripping across all home addresses associated with MN 102 in order to communicate with the HD.

More generally, using the present invention, when a mobile node having multiple associated home addresses initiates a new session with a host device for communicating with the host device, the mobile node uses one or more of the multiple home addresses associated with the mobile node for communicating with host device. In one embodiment, the home agent (e.g., one of the home agents associated with one of the multiple home addresses) selects one of the home addresses and communicates the selected home address to the mobile node. In another embodiment, the mobile node selects one of the multiple home addresses, or performs stripping across some or all of the home addresses, for communicating with the host device. In another embodiment, the naming server selects one of the home addresses based on the location of the host device. In such embodiments, the home address(es) may be selected in any manner (e.g., in a manner for optimizing the routing the path between the new host device and the mobile node, randomly for load balancing purposes, and the like).

As depicted in FIG. 2, in this example, the second home address (HomeAddr2) is selected because second HA 105₂ provides a better routing path to MN 102_{B} than first HA 105₁. Specifically, as depicted in FIG. 3, selection of the second home address (HomeAddr2) associated with second HA 105₂ results in the second routing path 202 along the route including second HD 104₂, RE 107₁₀, second HA 105₂, RE 107₆, and MN 102_{B}. By contrast, selection of the first home address (HomeAddr1) associated with first HA 105₁ would result in a much longer routing path from second HD 104₂ to MN 102_{B} that traverses, for example, RE 107₁₀, RE 107₉, RE 107₇, first HA 1051, RE 107₄, and RE 107₆ (which is clearly a longer path than second routing path 202).

Although omitted for purposes of clarity, as MN 102 continues to move within communication network 100, MN 102 may request additional home addresses from additional home agents (not depicted). The additional home addresses are assigned by home agents and propagated to MN 102 and NS 109 to be stored. Thus, although primarily depicted and described with respect to embodiments in which two home addresses are assigned to a mobile node, the present invention is not intended to be limited to a particular number of home addresses which are assigned to a mobile node and propagated to the mobile node and one or more naming servers which may be serving the communication network with which the mobile node is associated.

Thus, from FIG. 2, it can be seen that the present invention enables multiple home addresses of multiple home agents to be assigned to each mobile node associating with a mobile network. This enables the mobile node to move within the mobile communication network without losing existing sessions and in a manner for supporting new sessions that are more likely to use optimal routing paths than would otherwise be available in existing networks in which only one home address is associated with the mobile node at any given time. Thus, the present invention overcomes disadvantages of existing mobile communication networks.

The present invention overcomes disadvantages of existing networks in which a mobile node associates with a home agent statically because the mobile node now has multiple home agents available to support sessions. The present invention overcomes disadvantages of existing networks in which a mobile node associates with a home agent dynamically because the mobile node now is able to create new sessions with optimal routes independent of its location in the network even as it moves (due to its ability to associate with one than one home agent at a time). Furthermore, the present invention may be utilized regardless of whether the mobile node associates with the mobile network statically or dynamically.

The operation of components of the mobile communication network of FIG. 1 and FIG. 2 in providing mobility functions of the present invention may be better understood with respect to FIG. 3-FIG. 5.

FIG. 3 depicts a method according to one embodiment of the present invention. Specifically, method 300 of FIG. 3 includes a method for assigning multiple home addresses, associated with multiple mobile home agents, to a mobile node in a communication network running a mobility management protocol. The method 300 is depicted and described from the perspective of home agents of the mobile communication network. Although depicted and described as being performed serially, at least a portion of the steps of method 300 of FIG. 3 may be performed contemporaneously, or in a different order than depicted and described with respect to FIG. 3. The method 300 begins at step 302 and proceeds to step 304.

At step 304, a first home agent assigns a first home address to the mobile node.

At step 306, the first home agent, or another network device, propagates the first home address toward the mobile node, which receives and stores the first home address.

At step 308, the first home agent, the mobile node, or another network device, propagates the first home address toward a naming server. The naming server receives and stores the first home address.

At step 310, the first home agent, or a second home agent, assigns a second home address to the mobile node.

At step 312, the first home agent, the second home agent, or another network device, propagates the second home address toward the mobile node. The mobile node receives and stores the second home address while continuing to store the first home address.

At step 314, the first home agent, the second home agent, the mobile node, or another network device, propagates the second home address toward the naming server. The naming server receives and stores the second home address for the mobile node while continuing to store the first home address for the mobile node.

At step 316, method 300 ends.

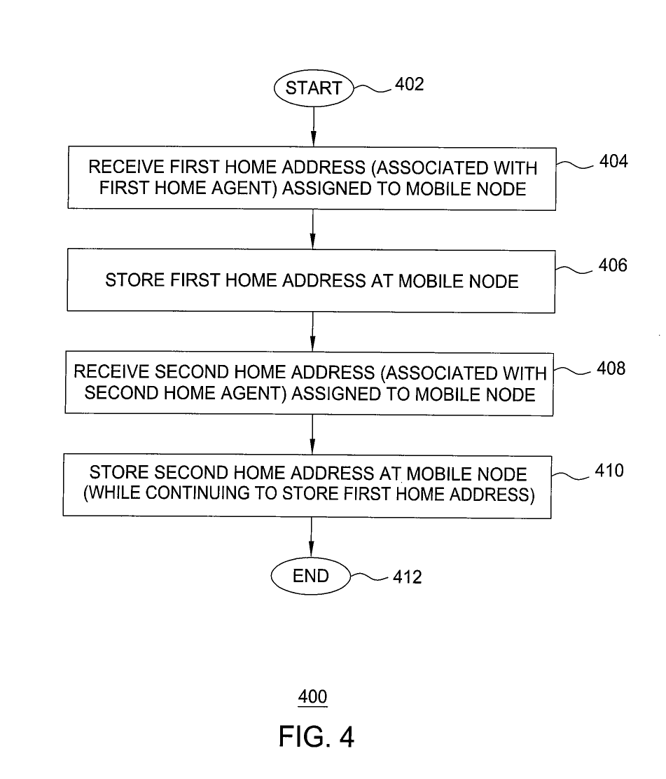

FIG. 4 depicts a method according to one embodiment of the present invention. Specifically, method 400 of FIG. 4 includes a method for assigning multiple home addresses, associated with multiple mobile home agents, to a mobile node in a communication network running a mobility management protocol. The method 400 is depicted and described from the perspective of the mobile node. Although depicted and described as being performed serially, at least a portion of the steps of method 400 of FIG. 4 may be performed contemporaneously, or in a different order than depicted and described with respect to FIG. 4. The method 400 begins at step 402 and proceeds to step 404.

At step 404, a first home address assigned to the mobile node is received at the mobile node. The first home address is associated with a first home agent. The first home address is assigned by the first home agent.

At step 406, the first home address is stored at the mobile node.

At step 408, a second address assigned to the mobile node is received at the mobile node. The second home address is associated with a second home agent. The second home address is assigned by the second home agent (or, alternatively, by the first home agent on behalf of the second home agent using some implicit agreement between the first home agent and second home agent or using some explicit communication between the first home agent and second home agent).

At step 410, the second home address is stored at the mobile node. The second home address is stored at the mobile node while the mobile node continues to store the first home address (i.e., the second home address does not replace the first home address at the mobile node because the mobile node is associated with both the first home agent and the second home agent contemporaneously).

At step 412, method 400 ends.

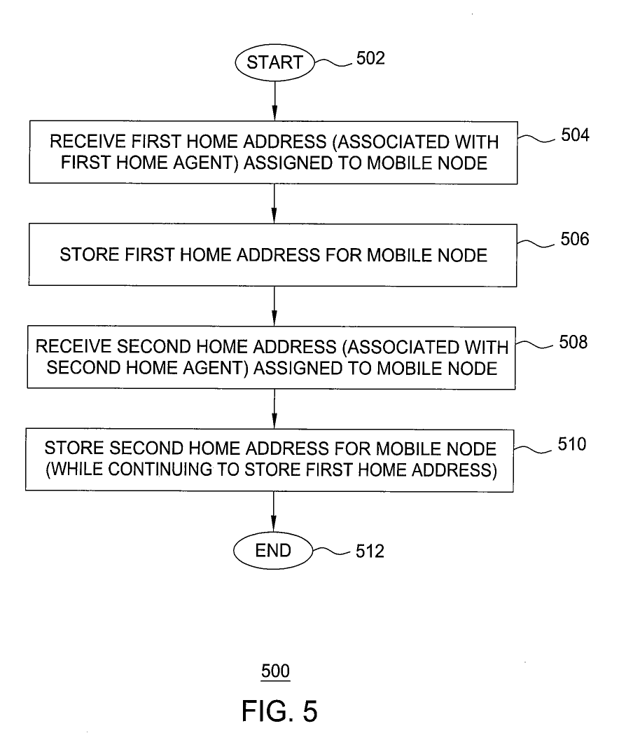

FIG. 5 depicts a method according to one embodiment of the present invention. Specifically, method 500 of FIG. 5 includes a method for assigning multiple home addresses, associated with multiple mobile home agents, to a mobile node in a communication network running a mobility management protocol. The method 500 is depicted and described from the perspective of a naming server serving the communication network. Although depicted and described as being performed serially, at least a portion of the steps of method 500 of FIG. 5 may be performed contemporaneously, or in a different order than depicted and described with respect to FIG. 5. The method 500 begins at step 502 and proceeds to step 504.

At step 504, a first home address assigned to the mobile node is received at the naming server. The first home address is associated with a first home agent. The first home address is assigned by the first home agent.

At step 506, the first home address is stored at the naming server. The first home address is stored such that it is associated with the mobile node.

At step 508, a second address assigned to the mobile node is received at the naming server. The second home address is associated with a second home agent. The second home address is assigned by the second home agent (or, alternatively, by the first home agent on behalf of the second home agent).

At step 510, the second home address is stored at the naming server. The second home address is stored at the naming server while the naming server continues to store the first home address (i.e., the second home address does not replace the first home address at the naming server because the mobile node is associated with both the first home agent and the second home agent contemporaneously).

At step 512, method 500 ends.

Although primarily depicted and described with respect to a specific event which triggers a MN to associate with a second HA while continuing to associate with a first HA (namely, when the MN moves from one physical location to another physical location), a MN may associate with a second HA while continuing to associate with a first HA in response to various other events or for various other reasons.

In one embodiment, for example, a MN may associate with a second HA while continuing to associate with a first HA without changing its physical location. For example, the MN may access the mobile communication network using different network interfaces (e.g., accessing the communication network via a first RE for a first session and accessing the communication network via a second RE for a second session, where the MN remains at or near the same physical location).

Although primarily depicted and described herein with respect to using Mobile IP as the mobility management protocol, the present invention may be used in conjunction with other mobility management protocols. For example, the present invention may be used in conjunction with mobility management protocols such as Hierarchical Mobile IPv6 (HMIPv6), Interactive Protocol for Mobile Networking (IPMN), and the like, as well as various combinations thereof. Although primarily depicted and described herein with respect to embodiments in which a home address is a network-layer address (e.g., IP address), in other embodiments, the addresses assigned to the mobile node may be assigned at different layers of the communication hierarchy.

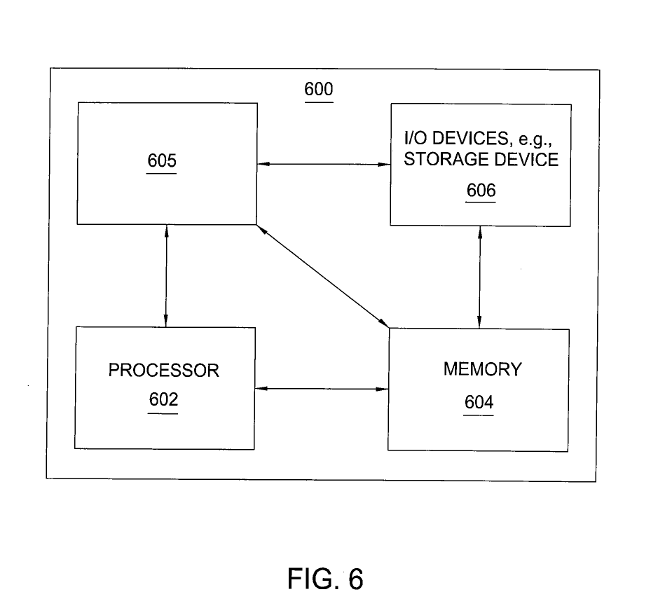

FIG. 6 depicts a high-level block diagram of a general-purpose computer suitable for use in performing the functions described herein. As depicted in FIG. 4, system 600 comprises a processor element 602 (e.g., a CPU), a memory 604, e.g., random access memory (RAM) and/or read only memory (ROM), a home address control module 605, and various input/output devices 606 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present home address control process 605 can be loaded into memory 604 and executed by processor 602 to implement the functions as discussed above. As such, home address control process 605 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for providing distributed control in a mobile communication network, comprising:
propagating, toward a mobile node, a first home address assigned to the mobile node, wherein the first home address is associated with a first mobility home agent; and
propagating, toward the mobile node, a second home address assigned to the mobile node, wherein the second home address is associated with a second mobility home agent, wherein the second home address is assigned to the mobile node while the first home address remains assigned to the mobile node.

2. The method of claim 1, wherein the first home address is assigned by the first mobility home agent.

3. The method of claim 1, wherein the second home address is assigned by one of the first mobility home agent and the second mobility home agent.

4. The method of claim 1, wherein:
the first home address is propagated toward the mobile node by at least one of the first home agent and another network device; and
the second home address is propagated toward the mobile node by at least one of the first home agent, the second home agent, and another network device.

5. The method of claim 1, further comprising:
propagating the first home address of the mobile node toward a naming server; and
propagating the second home address of the mobile node toward the naming server.

6. The method of claim 5, wherein:
the first home address is propagated toward the naming server by at least one of the first home agent, the mobile node, and another network device; and
the second home address is propagated toward the naming server by at least one of the first home agent, the second home agent, the mobile node, and another network device.

7. The method of claim 1, further comprising:
receiving, from a host, a request to contact the mobile node; and
providing, to the host, the first home address of the mobile node and the second home address of the mobile node.

8. A method for providing distributed control in a mobile communication network, comprising:
propagating, toward a naming server, a first home address assigned to the mobile node, wherein the first home address is associated with a first mobility home agent; and
propagating, toward the naming server, a second home address assigned to the mobile node, wherein the second home address is associated with a second mobility home agent;
wherein the naming server is adapted for storing the first home address and the second home address for the mobile node contemporaneously.

9. A method for providing distributed control in a mobile communication network, comprising:
receiving a first home address assigned for the mobile node, wherein the first home address is associated with a first mobility home agent;
storing the first home address for the mobile node;
receiving a second home address assigned for the mobile node, wherein the second home address is associated with a second mobility home agent; and
storing the second home address for the mobile node;
wherein the first home address continues to be stored for the mobile node when the second home address is stored for the mobile node.

10. The method of claim 9, wherein the first home address is assigned by the first mobility home agent.

11. The method of claim 9, wherein the first home address is received from at least one of the first mobility home agent, the mobile node, and another network device.

12. The method of claim 9, wherein the second home address is assigned by one of the second mobility home agent and the first mobility home agent.

13. The method of claim 9, wherein the second home address is received from at least one of the second mobility home agent, the first mobility home agent, the mobile node, and another network device.

14. The method of claim 9, further comprising:
in response to a request by a host to contact the mobile node, retrieving the first home address and the second home address associated with the mobile node.

15. The method of claim 14, further comprising one of:
propagating the first home address and the second home address toward the host; and
selecting one of the first home address and the second home address and propagating the selected home address toward the host.

16. A method for providing distributed control in a mobile communication network, comprising:
receiving a first home address assigned to the mobile node, wherein the first home address is associated with a first mobility home agent;
storing the first home address at the mobile node;
receiving a second home address assigned to the mobile node, wherein the second home address is associated with a second mobility home agent; and
storing the second home address at the mobile node;
wherein the first home address continues to be stored at the mobile node when the second home address is stored at the mobile node.

17. The method of claim 16, wherein the first home address is assigned by the first home agent.

18. The method of claim 16, wherein the second home address is assigned by one of the second mobility home agent and the first mobility home agent.

19. The method of claim 16, wherein:
the first home address is received from one of the first home agent and a naming server; and
the second address is received from one of the first mobility home agent, the second mobility home agent, and a naming server.

20. The method of claim 16, further comprising:
in response to a request by the mobile node to contact a host, selecting at least one of the first home address and the second home address; and
propagating information toward the selected ones of the first home address and the second home address.
